(19) United States
(12) Patent Application Publication
(10) Pub. No.: US 2011/0140949 A1
(43) Pub. Date: Jun. 16, 2011

(54) MIMO RADAR APPARATUS AND WIRELESS COMMUNICATION METHOD USING THE SAME

(75) Inventor: Moon-Sik LEE, Daejeon-si (KR)

(73) Assignee: Electronics and Telecommunications Research Institute, Daejeon-si (KR)

(21) Appl. No.: 12/841,595

(22) Filed: Jul. 22, 2010

(30) Foreign Application Priority Data
Dec. 16, 2009 (KR) 10-2009-0125666
Mar. 19, 2010 (KR) 10-2010-0024848

(51) Int. Cl. G01S 13/00; H01Q 3/00; G01S 13/42

(52) U.S. Cl. 342/28; 342/373; 342/107

(57) ABSTRACT

Provided are a multiple-input multiple-output (MIMO) radar apparatus and a wireless communication method using the same. The MIMO radar apparatus includes a transmitter generating and transmitting different signals having a frequency modulated continuous wave (FMCW) form to a moving object as a target through transmitting antennas of a transmitting antenna array respectively, and a receiver receiving echo signals which are the signals transmitted through the transmitting antennas and reflected from the moving object through receiving antennas of a receiving antenna array respectively. At least one of the transmitting antenna array and the receiving antenna array is a planar antenna array.

### CROSS-REFERENCE TO RELATED APPLICATION

This application claims the benefit under 35 U.S.C. §119(a) of Korean Patent Application Nos. 10-2009-0125666, filed on Dec. 16, 2009, and 10-2010-0024848, filed on Mar. 19, 2010, the entire disclosures of which are incorporated herein by references for all purposes.

### BACKGROUND

1. Field

The following description relates to wireless communication technology using an antenna array, and more particularly, to a multiple-input multiple-output (MIMO) radar apparatus and wireless communication method using the same.

2. Description of the Related Art

Antenna array technology is used to improve system performance in application fields such as wireless sensor network systems, super-high frequency imaging systems, intelligent traffic systems (ITSs), radar control systems, and so on. This antenna array technology has recently been regarded as critical technology for high-tech high-performance systems, and will probably acquire more important uses in the future.

Typical radar apparatuses using such an antenna array make use of a phase array, which transmits the same signal to all transmission antennas. A MIMO radar system has recently been proposed to improve target detection performance. This MIMO radar system transmits signals to respective antennas, so that it is possible to improve detection performance and obtain a high-resolution image.

### SUMMARY

The following description relates to antenna array technology, which makes it possible to provide simple configuration to a system, to accurately estimate movement parameters with respect to a moving object as a target, and to be applied to any conditions including a Gaussian noise condition and a non-Gaussian noise condition.

According to an exemplary aspect, there is provided a multiple-input multiple-output (MIMO) radar apparatus, which comprises: a transmitter generating and transmitting different signals having a frequency modulated continuous wave (FMCW) form to a moving object as a target through transmitting antennas of a transmitting antenna array respectively; and receiver receiving echo signals which are the different signals transmitted through the transmitting antennas respectively and reflected from the moving object through receiving antennas of a receiving antenna array respectively. Here, at least one of the transmitting antenna array and the receiving antenna array is a planar antenna array.

According to another exemplary aspect, there is provided a wireless communication method using an MIMO radar apparatus. The method comprises: generating and transmitting different signals having a an FMCW form to a moving object as a target through M transmitting antennas of a single linear transmitting antenna array respectively; receiving echo signals of the signals transmitted to the moving object from the moving object respectively through receiving antennas arranged in a K×L matrix and constituting a planar receiving antenna array having L linear receiving antenna arrays; and mixing the received echo signals with the transmitted signals to generate mixed signals, and converting the mixed signals into digital signals.

According to yet another exemplary aspect, there is provided a wireless communication method using an MIMO radar apparatus. The method comprises: generating and transmitting different signals having an FMCW form to a moving object as a target respectively through transmitting antennas arranged in an M×N matrix and constituting a planar transmitting antenna array having M linear transmitting antenna arrays; receiving echo signals of the signals transmitted to the moving object from the moving object respectively through L receiving antennas of a single linear receiving antenna array having L linear receiving antenna arrays; and mixing the received echo signals with the transmitted signals to generate mixed signals, and converting the mixed signals into digital signals.

According to still yet another exemplary aspect, there is provided a wireless communication method using an MIMO radar apparatus. The method comprises: generating and transmitting different signals having an FMCW form to a moving object as a target respectively through transmitting antennas arranged in an M×N matrix and constituting a planar transmitting antenna array having M linear transmitting antenna arrays; receiving echo signals of the signals transmitted to the moving object from the moving object respectively through receiving antennas arranged in a K×L matrix and constituting a planar receiving antenna array having L linear receiving antenna arrays; and mixing the received echo signals with the transmitted signals to generate mixed signals, and converting the mixed signals into digital signals.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 illustrates configuration of a linear antenna array according to an exemplary embodiment of the present invention.

FIG. 2 illustrates configuration of a planar antenna array according to an exemplary embodiment of the present invention.

FIG. 3 illustrates a structure of a multiple-input multiple-output (MIMO) radar apparatus constituted of a transmitter using a linear antenna array structure and a receiver using a planar antenna array structure in accordance with an exemplary embodiment of the present invention.

FIG. 4 illustrates a structure of a MIMO radar apparatus constituted of a transmitter using a planar antenna array structure and a receiver using a linear antenna array structure in accordance with an exemplary embodiment of the present invention.

FIG. 5 illustrates a structure of a MIMO radar apparatus constituted of a transmitter using a planar antenna array structure and a receiver using a planar antenna array structure in accordance with an exemplary embodiment of the present invention.

FIGS. 6A and 6B are waveform diagrams of a transmitted signal according to an exemplary embodiment of the present invention.

FIG. 7 is a flowchart illustrating a wireless communication method using the planar antenna array of an MIMO radar apparatus according to an exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

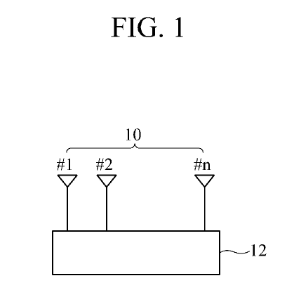

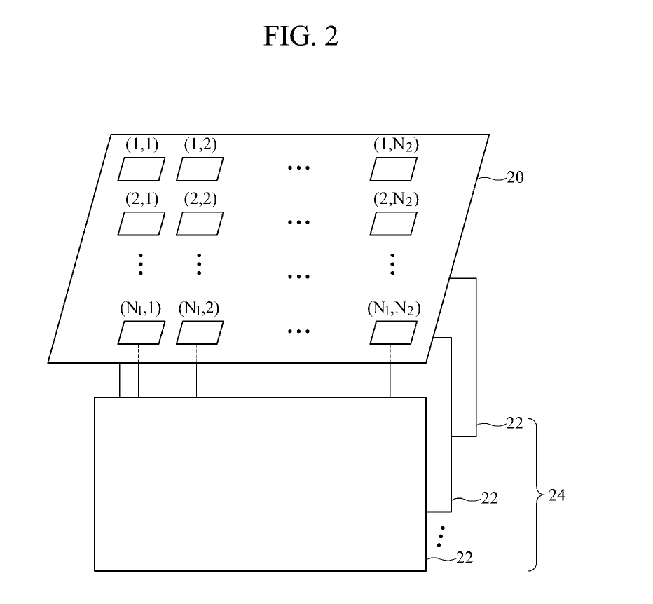

FIG. 1 illustrates configuration of a linear antenna array according to an exemplary embodiment of the present invention. FIG. 2 illustrates configuration of a planar antenna array according to an exemplary embodiment of the present invention.

A multiple-input multiple-output (MIMO) radar apparatus includes a transmitter and a receiver. The transmitter transmits a signal to a moving object, i.e. a target, through an antenna array, and then the receiver receives an echo signal of the transmitted signal from the target through an antenna array. Here, the MIMO radar apparatus may estimate movement parameters of the moving object by transceiving the signal between the transmitter and the receiver. The movement parameters include information about the moving object, i.e. an azimuth, velocity, range, and time of the moving object.

Referring to FIG. 1, an antenna array structure known as a linear antenna array structure includes N antennas 10, and a single linear antenna array 12. Referring to FIG. 2, a planar antenna array structure includes antennas 20 arranged in an n₁×n₂ matrix, and a planar antenna array 24 constituted of n₁ linear antenna arrays.

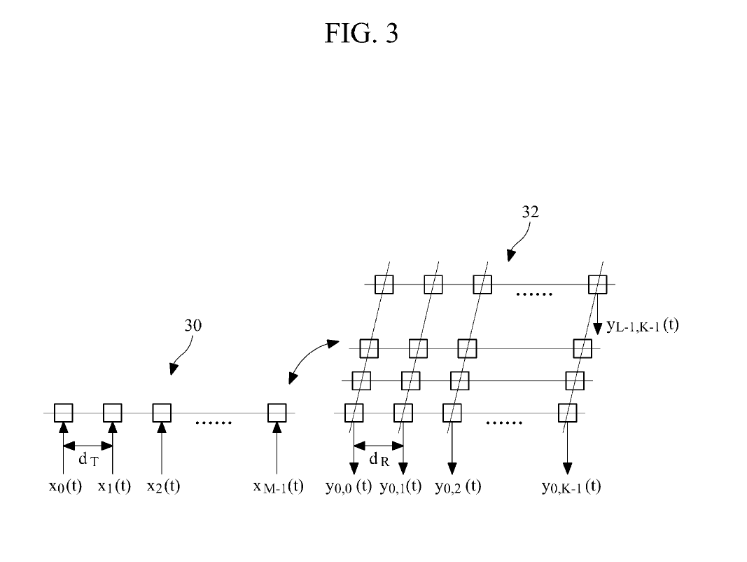

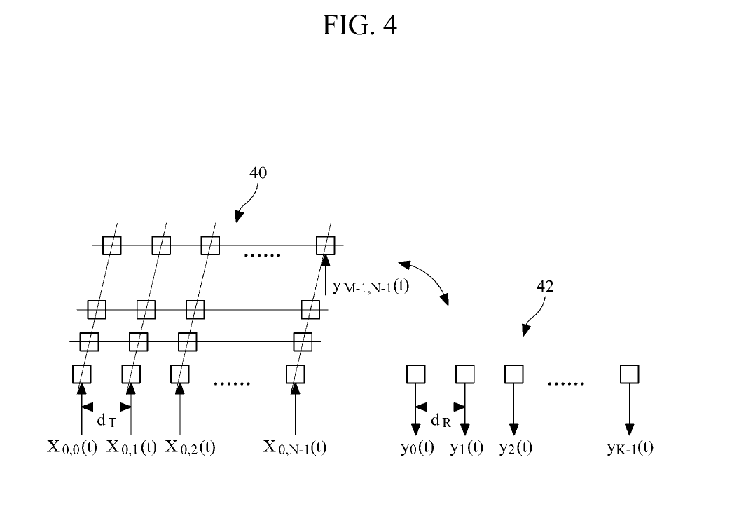

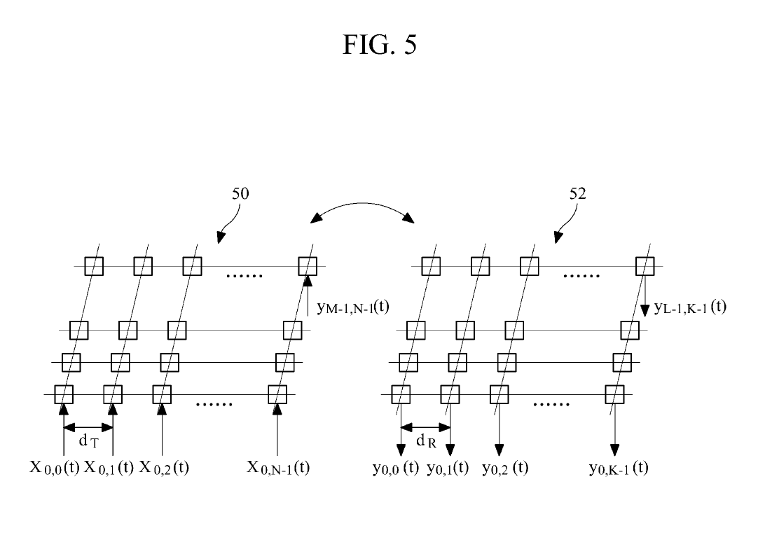

According to the present invention, at least one of the transmitter and the receiver has the planar antenna array structure. In detail, according to an exemplary embodiment, as illustrated in FIG. 3, the transmitter has the linear antenna array structure, and the receiver has the planar antenna array structure. According to another exemplary embodiment, as illustrated in FIG. 4, the transmitter has the planar antenna array structure, and the receiver has the linear antenna array structure. According to yet another exemplary embodiment, as illustrated in FIG. 5, the transmitter has the planar antenna array structure, and the receiver also has the planar antenna array structure.

As described above, since at least one of the transmitter and the receiver has the planar antenna array structure, it is possible to accurately estimate the movement parameters of the target, i.e. the moving object. Hereinafter, a structure of the MIMO radar apparatus according to various exemplary embodiments of the present invention will be described in detail with reference to FIGS. 3 through 5.

FIG. 3 illustrates a structure of a MIMO radar apparatus constituted of a transmitter using a linear antenna array structure and a receiver using a planar antenna array structure in accordance with an exemplary embodiment of the present invention.

Referring to FIG. 3, the transmitter 30 according to an exemplary embodiment of the present invention has a linear transmitting antenna array structure. Here, the transmitter 30 transmits different signals to a moving object, i.e. a target, through M transmitting antennas. The transmitted signals have a frequency modulated continuous wave (FMCW) form. Since the transmitted signals have the FMCW form rather than a pulse wave form, it is possible to simplify realization of a system and reduce a loss of power.

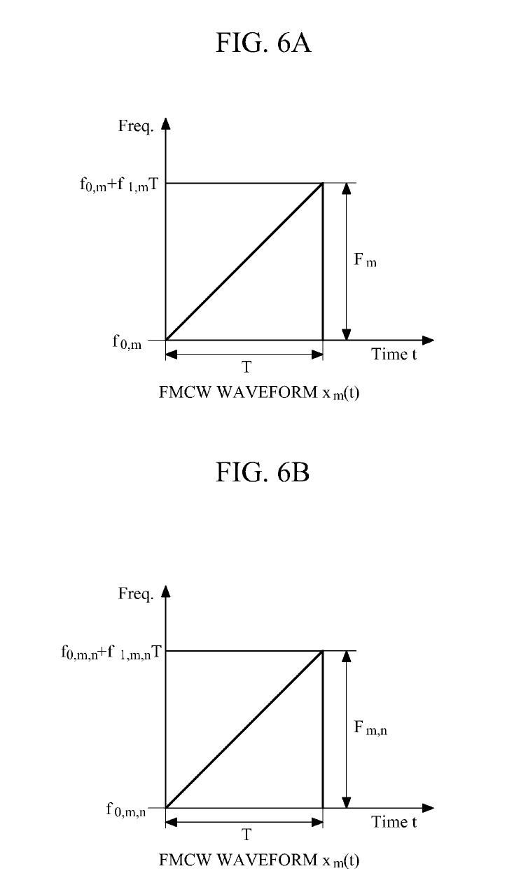

In detail, the signal of the FMCW form, which is transmitted to the m-th receiving antenna of the receiver 32 through the transmitter 30, can be expressed as xₘ(t)=exp[j2π(f_{0,m}t+f_{1,m}t²/2)], 0≦t<T, where T is the pulse period, f_{0,m} is the initial frequency used when the signal is transmitted to the m-th receiving antenna, and f_{1,m} is the chirp rate used when the signal is transmitted to the m-th receiving antenna. Further, f_{1,m} is given as Fₘ/T, where Fₘ is the bandwidth. The transmitted signal of the FMCW form has a waveform diagram as illustrated in FIG. 6A. In FIG. 3, d_{T} and d_{R} indicate an antenna spacing of the transmitting antenna array, and an antenna spacing of the receiving antenna array, respectively.

Meanwhile, the receiver 32 according to an exemplary embodiment has a planar receiving antenna array structure constituted of L linear antenna arrays. Receiving antennas of the receiver 32, which are arranged in a K×L matrix, receive respective echo signals of the signals, which are transmitted to the moving object through the transmitter 30, from the moving object.

The planar receiving antenna array according to an exemplary embodiment receives the echo signals through the receiving antennas of the receiver 32, which are arranged in a K×L matrix. The echo signal received through each receiving antenna is mixed with the transmitted signal, thereby generating a mixed signal, and converting it into a digital signal. Here, the planar receiving antenna array may select at least one of the receiving antennas, and receive the echo signal through the selected receiving antenna. The selection of the receiving antenna may be done by a switch.

Meanwhile, according to another aspect of the present invention, the receiver 32 estimates movement parameters of the moving object from the mixed signal that is received through the receiving antenna and then converted into the digital signal. The movement parameters include information about the moving object, i.e. at least one of an azimuth, velocity, range, and time of the moving object.

In detail, the receiver 32 steers the digital signal using a first steering vector including the information about the angle, velocity and range of the moving object with respect to the transmitting antenna array, a second steering vector including the information about the angle of the moving object with respect to the receiving antenna array, and a noise vector in which a desired signal vector is mixed with noise.

Meanwhile, the receiver 32 according to the present invention applies mini-max M-estimation to the digital signal. In this case, the receiver 32 may be applied on any conditions including a Gaussian noise condition that follows Gaussian distribution and a non-Gaussian noise condition that does not follow Gaussian distribution.

In general, noise of physical radio wave environments such as wireless communication and radar environments is known as impulsive non-Gaussian noise. The impulsive non-Gaussian noise may reduce performance of an algorithm based on Gaussian assumption. However, according to the present invention, the receiver can be used in these impulsive non-Gaussian noise environments due to the application of the mini-max M-estimation.

To this end, the receiver 32 calculates an estimate value of the desired signal vector using a loss function and a residual vector. The movement parameters of the moving object are estimated using the calculated estimate value of the desired signal vector. Here, the loss function is a secondary-primary loss function of Huber or a loss function of Hampel, and can be used on the Gaussian noise condition and the non-Gaussian noise condition.

Hereinafter, a signal receiving method of the receiver 32 according to the present invention will be described in detail. First, the signal received through the receiver 32 is expressed as in Equation 1 below.

y(t)=ga^{c}(θ,ν,ρ)b*(θ)s(t)+u(t) Equation 1

where g is the attenuated signal magnitude, a(θ,ν,ρ) is the steering vector of the transmitting antenna array, b(θ) is the steering vector of the receiving antenna array, θ is the angle of the target, ν is the velocity of the target, ρ is the range of the target, and u(t) is the vector in which noise is mixed with another signal. s(t) is the desired signal vector, and can be expressed as in s(t)=[s₀(t), s₁(t), . . . , s_{M-1}(t)]^{T}, where (•)^{T} is the transpose, (•)^{c} is the complex conjugate number, and (•)* is the conjugate transpose.

Meanwhile, the estimate value of s(t) is obtained using a reference function, J(s(t),θ,ν,ρ), of Equation 2.

$$J ( s ( t ) , θ , v , ρ ) = {\sum }_{k = 0}^{K - 1} [ F ( {e}_{I , l} ( t ) ) + F ( {e}_{Q , l} ( t ) ) ] \\ e ( t ) = y ( t ) - g {a}^{c} ( θ , v , ρ ) {b}^{*} ( θ ) s ( t ) \qquad Equation 2$$

where F(x) is the loss function, e(t) is the residual vector, and I and Q are inphase and quadrature components of a variable, respectively.

In Equation 2, the loss function, F(x), is obtained so as to be robust against the noise condition by a mini-max theory. In the present invention, the secondary-primary loss function proposed by Huber, and the loss function proposed by Hampel are used. Both the secondary-primary loss function proposed by Huber and the loss function proposed by Hampel are expressed as in Equations 3 and 4, respectively.

$$\begin{matrix} F ( x ) = \{ \begin{matrix}\frac{1}{2} {x}^{2} , & \vert x \vert \leq μ \\ μ \vert x \vert - \frac{1}{2} {μ}^{2} , & \vert x \vert > μ\end{matrix} & Equation 3 \\ F ( x ) = \{ \begin{matrix}\frac{1}{2} {x}^{2} , & \vert x \vert \leq {μ}_{1} \\ {μ}_{1} \vert x \vert - \frac{1}{2} {μ}_{1}^{2} , & {μ}_{1} < \vert x \vert \leq {μ}_{2} \\ \frac{{μ}_{1} ( {μ}_{2} + {μ}_{3} ) - {μ}_{1}^{2} + {μ}_{1} \frac{{( \vert x \vert - {μ}_{3} )}^{2}}{{μ}_{2} - {μ}_{3}}}{2} , & {μ}_{2} < \vert x \vert \leq {μ}_{3} \\ \frac{{μ}_{1} ( {μ}_{2} + {μ}_{3} ) - {μ}_{1}^{2}}{2} , & \vert x \vert > {μ}_{3}\end{matrix} & Equation 4\end{matrix}$$

Thus, the estimate value of s(t) can be obtained as in Equation 5.

$$( \hat{θ} , \hat{v} , \hat{ρ} ) = arg {max}_{θ , v , ρ} P ( θ , v , ρ ) \\ P ( θ , v , ρ ) = \frac{1}{W} {\sum }_{t} {\vert \hat{s} ( t ) \vert}^{2} \qquad Equation 6$$

In this case, the information about the moving object, i.e. the angle, velocity, and range of the moving object, and a power function, P(θ,ν,ρ), can be obtained as in Equation 6.

$$\hat{s} ( t ) = arg {min}_{s ( t )} J ( s ( t ) , θ , v , ρ ) \qquad Equation 5$$

where W is the total number of observation.

FIG. 4 illustrates a structure of a MIMO radar apparatus constituted of a transmitter using a planar antenna array structure and a receiver using a linear antenna array structure in accordance with an exemplary embodiment of the present invention.

Referring to FIG. 4, the planar antenna array structure of the transmitter 40 includes M linear antenna arrays, and transmits signals through transmitting antennas arranged in an M×N matrix. The transmitted signals have an FMCW form.

According to an exemplary embodiment, the transmitted signal of the FMCW form is expressed as x_{m,n}(t)=exp[j2π(f_{0,m,n}t+f_{1,m,n}t²/2)], 0≦t<T, where f_{0,m,n} is the initial frequency used when the signal is transmitted to the (m, n)-th receiving antenna, and f_{1,m,n} is the chirp rate used when the signal is transmitted to the (m, n)-th receiving antenna. Further, f_{1,m,n} is given as F_{m,n}/T, where F_{m,n} is the bandwidth. The transmitted signal of the FMCW form has a waveform diagram as illustrated in FIG. 6A. Since the transmitted signals have the FMCW form rather than a pulse wave form, it is possible to simplify realization of a system and reduce a loss of power.

Meanwhile, the receiver 42 according to an exemplary embodiment has a single linear receiving antenna array structure. In the linear receiving antenna array structure of the receiver 42, L receiving antennas receive respective echo signals of the signal transmitted to a moving object. The echo signal received through each receiving antenna is mixed with the transmitted signal, thereby generating a mixed signal, and converting it into a digital signal. Here, the linear receiving antenna array may select at least one of the receiving antennas, and receive the echo signal through the selected receiving antenna. The selection of the receiving antenna may be done by a switch.

Further, the receiver 42 estimates movement parameters of the moving object from the mixed signal that is received through the receiving antenna and then converted into the digital signal. The movement parameters include information about the moving object, i.e. an azimuth, velocity, range, and time of the moving object. Here, the receiver 42 steers the digital signal using a first steering vector including the information about the angle, velocity and range of the moving object with respect to the transmitting antenna array, a second steering vector including the information about the angle of the moving object with respect to the receiving antenna array, and a noise vector in which a desired signal vector is mixed with noise.

As described above with reference to FIG. 3, the receiver 42 according to the present invention applies mini-max M-estimation to the digital signal. In this case, the receiver 42 may be realized on any conditions including a Gaussian noise condition that follows Gaussian distribution and a non-Gaussian noise condition that does not follow Gaussian distribution.

FIG. 5 illustrates a structure of a MIMO radar apparatus constituted of a transmitter using a planar antenna array structure and a receiver using a planar antenna array structure in accordance with an exemplary embodiment of the present invention.

Referring to FIG. 5, the planar antenna array structure of the transmitter 50 includes M linear antenna arrays, and transmits signals through transmitting antennas arranged in an M×N matrix. Here, the transmitted signals have an FMCW form. According to an exemplary embodiment, the transmitted signal of the FMCW form is expressed as x_{m,n}(t)=exp[j2π(f_{0,m,n}t+f_{1,m,n}t²/2)], 0≦t<T, where f_{0,m,n} is the initial frequency used when the signal is transmitted to the (m, n)-th receiving antenna, and f_{1,m,n} is the chirp rate used when the signal is transmitted to the (m, n)-th receiving antenna. Further, f_{1,m,n} is given as F_{m,n}/T, where F_{m,n} is the bandwidth. Since the transmitted signals have the FMCW form rather than a pulse wave form, it is possible to simplify realization of a system and reduce a loss of power.

Meanwhile, the receiver 52 according to an exemplary embodiment has a planar receiving antenna array structure constituted of L linear antenna arrays. Receiving antennas of the receiver 52, which are arranged in a K×L matrix, receive respective echo signals of the signals transmitted to a moving object through the transmitter 50. The planar receiving antenna array mixes the echo signal received through each receiving antenna is mixed with the transmitted signal, thereby generating a mixed signal, and converting it into a digital signal. Here, at least one of the receiving antennas may be selected to receive the echo signal. The selection of the receiving antenna may be done by a switch.

As described above with reference to FIG. 3, the receiver 52 according to the present invention applies mini-max M-estimation to the digital signal. In this case, the receiver 52 may be realized on any conditions including a Gaussian noise condition that follows Gaussian distribution and a non-Gaussian noise condition that does not follow Gaussian distribution.

FIGS. 6A and 6B are waveform diagrams of a transmitted signal according to an exemplary embodiment of the present invention.

Referring to FIG. 6A, when the transmitter has a linear antenna array structure, and the receiver has a planar antenna array structure, the signal transmitted to an m-th receiving antenna can be expressed as xₘ(t)=exp[j2π(f_{0,m}t+f_{1,m}t²/2)], 0≦t<T, where T is the pulse period, f_{0,m} is the initial frequency used when the signal is transmitted to the m-th receiving antenna, and f_{1,m} is the chirp rate used when the signal is transmitted to the m-th receiving antenna. Further, f_{1,m} is given as Fₘ/T, where Fₘ is the bandwidth.

Referring to FIG. 6B, when the transmitter has a planar antenna array structure, and the receiver has a linear or planar antenna array structure, the transmitted signal of the FMCW form is expressed as x_{m,n}(t)=exp[j2π(f_{0,m,n}t+f_{1,m,n}t²/2)], 0≦t<T, where f_{0,m,n} is the initial frequency used when the signal is transmitted to the (m, n)-th receiving antenna, and f_{1,m,n} is the chirp rate used when the signal is transmitted to the (m, n)-th receiving antenna. Further, f_{1,m,n} is given as F_{m,n}/T, where F_{m,n} is the bandwidth.

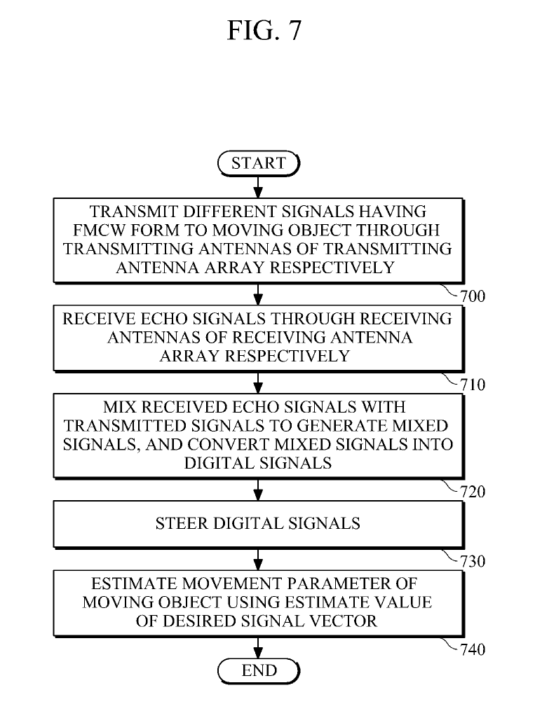

FIG. 7 is a flowchart illustrating a wireless communication method using the planar antenna array of a MIMO radar apparatus according to an exemplary embodiment of the present invention.

First, at least one of the transmitter and the receiver of the MIMO radar apparatus has a planar receiving antenna array structure constituted of a plurality of linear receiving antenna arrays.

Referring to FIG. 7, the MIMO radar apparatus generates different signals, which have an FMCW form, through the transmitting antenna array, and transmits the generated signals to a target, i.e. a moving object (700). Then, the MIMO radar apparatus receives echo signals of the signals transmitted to the moving object through a plurality of receiving antennas of the receiving antenna array (710). Next, the MIMO radar apparatus mixes the received echo signals with the transmitted signals, thereby generating mixed signals and converting them into digital signals (720).

Furthermore, the MIMO radar apparatus steers the mixed signals converted into the digital signals using a first steering vector including information about an angle, velocity and range of the moving object with respect to the transmitting antenna array, a second steering vector including information about the angle of the moving object with respect to the receiving antenna array, and a noise vector in which a desired signal vector is mixed with noise (730).

Subsequently, the MIMO radar apparatus calculates an estimate value of the desired signal vector using a loss function and a residual vector, and estimates at least one movement parameter including at least one of the angle, velocity, and range of the moving object using the calculated estimate value of the desired signal vector (740). Here, the loss function is a secondary-primary loss function of Huber or a loss function of Hampel, and can be applied on the Gaussian noise condition and the non-Gaussian noise condition.

According to an exemplary embodiment, since at least one of the transmitter and the receiver of the MIMO radar apparatus has the planar antenna array structure, it is possible to accurately estimate the movement parameters of the moving object,

Furthermore, since the signals transmitted through the transmitter have the FMCW form rather than a pulse wave form, it is possible to simplify realization of a system and reduce a loss of power.

In addition, since mini-max M-estimation is applied when the receiver receives the signals, it can be applied on any conditions including a Gaussian noise condition that follows Gaussian distribution and a non-Gaussian noise condition that does not follow Gaussian distribution.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A multiple-input multiple-output (MIMO) radar apparatus, comprising:
a transmitter generating and transmitting different signals having a frequency modulated continuous wave (FMCW) form to a moving object as a target through transmitting antennas of a transmitting antenna array respectively; and
a receiver receiving echo signals which are the different signals transmitted through the transmitting antennas respectively and reflected from the moving object through receiving antennas of a receiving antenna array respectively,
wherein at least one of the transmitting antenna array and the receiving antenna array is a planar antenna array.

2. The MIMO radar apparatus of claim 1, wherein the transmitter includes:
the transmitting antennas arranged in an M×N matrix and transmitting the signals to the moving object respectively; and
the planar transmitting antenna array constituted of M linear antenna arrays controlling the transmitting antennas arranged in the M×N matrix to transmit the signals respectively.

3. The MIMO radar apparatus of claim 1, wherein the receiver includes:
the receiving antennas arranged in a K×L matrix and receiving the echo signals from the moving object respectively; and
the planar receiving antenna array constituted of L linear antenna arrays mixing the echo signals respectively received by the receiving antennas arranged in the K×L matrix with the transmitted signals to generate mixed signals, and converting the mixed signals into digital signals.

4. The MIMO radar apparatus of claim 1, wherein the receiver estimates a movement parameter including at least one of an angle, a velocity, and a range of the moving object from the signals respectively received through the receiving antennas.

5. The MIMO radar apparatus of claim 4, wherein the receiver steers the signals respectively received through the receiving antennas using a first steering vector including information about an angle, a velocity, and a range of the moving object with respect to the transmitting antenna array, a second steering vector including information about an angle of the moving object with respect to the receiving antenna array, and a noise vector in which a desired signal vector is mixed with noise.

6. The MIMO radar apparatus of claim 5, wherein the receiver calculates an estimate value of the desired signal vector using a loss function and a residual vector, and estimates the movement parameter of the moving object using the calculated estimate value of the desired signal vector.

7. The MIMO radar apparatus of claim 6, wherein the loss function is a secondary-primary loss function of Huber or a loss function of Hampel, and is applied on a Gaussian noise condition and a non-Gaussian noise condition.

8. A wireless communication method using a multiple-input multiple-output (MIMO) radar apparatus, the method comprising:
generating and transmitting different signals having a frequency modulated continuous wave (FMCW) form to a moving object as a target through M transmitting antennas of a single linear transmitting antenna array respectively;
receiving echo signals of the signals transmitted to the moving object from the moving object respectively through receiving antennas arranged in a K×L matrix and constituting a planar receiving antenna array having L linear receiving antenna arrays; and
mixing the received echo signals with the transmitted signals to generate mixed signals, and converting the mixed signals into digital signals.

9. The method of claim 8, further comprising:
steering the digital signals using a first steering vector including information about an angle, a velocity, and a range of the moving object with respect to the linear transmitting antenna array, a second steering vector including information about an angle of the moving object with respect to the planar receiving antenna array, and a noise vector in which a desired signal vector is mixed with noise; and
calculating an estimate value of the desired signal vector using a loss function and a residual vector, and estimating a movement parameter including at least one of the angle, the velocity, and the range of the moving object using the calculated estimate value of the desired signal vector.

10. The method of claim 9, wherein the loss function is a secondary-primary loss function of Huber or a loss function of Hampel, and is applied on a Gaussian noise condition and a non-Gaussian noise condition.

11. A wireless communication method using a multiple-input multiple-output (MIMO) radar apparatus, the method comprising:
generating and transmitting different signals having a frequency modulated continuous wave (FMCW) form to a moving object as a target respectively through transmitting antennas arranged in an M×N matrix and constituting a planar transmitting antenna array having M linear transmitting antenna arrays;
receiving echo signals of the signals transmitted to the moving object from the moving object respectively through L receiving antennas of a single linear receiving antenna array having L linear receiving antenna arrays; and
mixing the received echo signals with the transmitted signals to generate mixed signals, and converting the mixed signals into digital signals.

12. The method of claim 11, further comprising:
steering the digital signals using a first steering vector including information about an angle, a velocity, and a range of the moving object with respect to the planar transmitting antenna array, a second steering vector including information about an angle of the moving object with respect to the linear receiving antenna array, and a noise vector in which a desired signal vector is mixed with noise; and
calculating an estimate value of the desired signal vector using a loss function and a residual vector, and estimating a movement parameter including at least one of the angle, the velocity, and the range of the moving object using the calculated estimate value of the desired signal vector.

13. The method of claim 12, wherein the loss function is a secondary-primary loss function of Huber or a loss function of Hampel, and is applied on a Gaussian noise condition and a non-Gaussian noise condition.

14. A wireless communication method using a multiple-input multiple-output (MIMO) radar apparatus, the method comprising:
generating and transmitting different signals having a frequency modulated continuous wave (FMCW) form to a moving object as a target respectively through transmitting antennas arranged in an M×N matrix and constituting a planar transmitting antenna array having M linear transmitting antenna arrays;
receiving echo signals of the signals transmitted to the moving object from the moving object respectively through receiving antennas arranged in a K×L matrix and constituting a planar receiving antenna array having L linear receiving antenna arrays; and
mixing the received echo signals with the transmitted signals to generate mixed signals, and converting the mixed signals into digital signals.

15. The method of claim 14, further comprising:
steering the digital signals using a first steering vector including information about an angle, a velocity and a range of the moving object with respect to the planar transmitting antenna array, a second steering vector including information about an angle of the moving object with respect to the planar receiving antenna array, and a noise vector in which a desired signal vector is mixed with noise; and
calculating an estimate value of the desired signal vector using a loss function and a residual vector, and estimating at least one movement parameter including at least one of the angle, the velocity, and the range of the moving object using the calculated estimate value of the desired signal vector.

16. The method of claim 15, wherein the loss function is a secondary-primary loss function of Huber or a loss function of Hampel, and is applied on a Gaussian noise condition and a non-Gaussian noise condition.
